(19) United States
(12) Patent Application Publication
(10) Pub. No.: US 2005/0243144 A1
(43) Pub. Date: Nov. 3, 2005

(54) System and method of manufacturing mono-sized-disbursed spherical particles

(75) Inventors: Robert C. Dean JR., Norwich, VT (US); Joseph J. Brown, Norwich, VT (US); Charles M. Hackett, Hanover, NH (US); Charles R. Sullivan, W. Lebanon, NH (US)

Correspondence Address: BOURQUE & ASSOCIATES, P.A., 835 HANOVER STREET, SUITE 303, MANCHESTER, NH, 03104, US

(73) Assignee: Synergy Innovations, Inc., Lebanon, NH (US)

(21) Appl. No.: 11/103,368

(22) Filed: Apr. 11, 2005

Related U.S. Application Data
(60) Provisional application No. 60/560,994, filed on Apr. 9, 2004.
(60) Provisional application No. 60/652,869, filed on Feb. 15, 2005.

(51) Int. Cl. B41J 2/07

(52) U.S. Cl. 347/74

(57) ABSTRACT

A method and apparatus for forming mono-sized-dispersed spherical particles from a conductive liquid utilizes inductive coupling to cause a pressure oscillation in a plenum feeding a jet-forming nozzle. The inductive coupling is provided by a transformer where one loop is the conductive liquid. The invention also features a device with single or multiple orifice nozzle plates reliably manufactured using etching techniques. The invention also features methods for protecting jet-forming orifices from destruction attack by a corrosive liquid. The invention also features means to create simultaneously, tailored mixtures of mono-size-dispersed powder sizes. The invention also features a system and method for “pre-wetting” fine pores and orifices and for encouraging liquid penetration of the fine pores and filter without recourse to very high differential pressure.

### CROSS-REFERENCE TO RELATED APPLICATIONS

This application claims the benefit of U.S. Provisional Application No. 60/560,994, filed Apr. 9, 2004 and U.S. Provisional Application Ser. No. 60/652,869, filed Feb. 15, 2005.

### TECHNICAL FIELD

The present invention relates to the formation of liquid droplets, and more particularly, to a method and apparatus for forming uniform droplets in a liquid flow of material, such as a conductive metal, utilizing induction coupled pressure oscillations induced in the liquid flow, to a system and method for providing single or multi-orificed nozzle plates for generating such uniform droplets and to a system and method for inducing liquid penetration through fine orifices and filters.

### BACKGROUND INFORMATION

There are many uses for very small, very uniformly shaped spheres made of material such a metal, tin, lead and the like. Also, the same method may be employed to form uniform spheres of some ceramics, composites, polymers, glasses, organic and inorganic gels, including sol-gels and the like. Making these uniformly shaped spheres can, however, be difficult and costly. The present invention features using a stream of liquid to form such spheres.

Any liquid jet with a non-zero surface tension, given enough time, will break up into droplets via the phenomenon of surface-tension-driven Rayleigh instability, as first described by Lord Rayleigh in 1873. It is well known in the art that exciting a liquid jet at its particular strongest-instability frequency is necessary to form, from the flow, a well-regulated train of equal-size drops. Further, it is known that small drops, called “satellites” will form between the primary drops unless a particular excitation waveform is imposed on the flow.

The prior art discloses several methods for generating and transmitting an excitation waveform to a liquid flow. These methods include introducing turbulence into a stream of liquid or using means, such as vibration of the jet-forming nozzle or piezo-electric transducers, to impart an excitation waveform to the liquid flow. When the liquid flow is molten metal, however, several challenges are presented that cannot be fulfilled by the prior art.

Some examples of challenges that the PA is unable to overcome includes the need to generate the excitation in a superheated environment, the need to work with fluids (such as molten metals), and other molten substances that are conductive, and the need to produce very small drops by the Rayleigh jet instability requires high frequencies (e.g., for 1 μm diameter drops moving at 10 m/s, the preferred excitation frequency is 5 MHz). These challenges do not lend themselves to the methodologies of the prior art.

In order to be commercially viable, a system and method for producing uniform drops should be able to generate many thousands or millions of droplets nearly simultaneously. Such a requirement generates a need to reliably and relatively inexpensively manufacture nozzles having very small orifices, centered extremely close together, and which will withstand the erosion or interaction with the material flowing through the nozzle.

Finally, the filtration or passage of relatively high surface tension liquids through filter pores, orifices, and the like having diameters smaller than approximately 5 μm is problematic because of the high pressure differential needed to overcome the liquid's surface tension, if the liquid does not “wet” the filter, in order to establish a flow through the filter pores or through an orifice to form a jet.

Accordingly, the prior art suffers from several disadvantages. Therefore, there exists a need for a system and method for quickly, reliably, and inexpensively producing uniform droplets in a liquid flow of material, such as a conductive metal. The also exists a need for a system and method for providing single or multi-orificed nozzle plates for generating such uniform droplets and for a system and method for inducing liquid penetration through fine orifices and filters.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features a method of forming droplets. The method includes the acts of providing a conductive fluid. The conductive fluid preferably includes a liquid metal, salt solution, a solgel, or a nonconductive fluid doped to make it conductive. Next, a current is created in the conductive fluid using induction, a pressure perturbation is created in the conductive fluid using the Lorentz phenomenon, and the conductive fluid is discharged through at least one nozzle. The pressure perturbation is preferably created using the Lorentz phenomenon at approximately the Rayleigh frequency of jet instability.

The act of creating the pressure perturbation in the conductive fluid preferably includes using the Lorentz phenomenon further includes using a magnetohydrodynamic (MHD) apparatus. The MHD apparatus preferably includes at least one high-frequency transformer primary coil, a secondary coil formed from the conductive fluid, and a DC magnet.

The current may be created in the conductive fluid using induction performed after the act of discharging the conductive fluid from the at least one nozzle. Alternatively, the current is created in the conductive fluid using induction and includes the acts of providing at least one coil disposed at or below a jet breakup point of the conductive fluid, applying an AC and a DC current to the at least one coil, and passing the conductive fluid through the at least one coil. An AC and the DC current may be applied to a first and at least a second coil, respectively. Alternatively, the AC and DC current may be superimposed and applied to a first coil.

Optionally, a buffer layer is created between the nozzle and the conductive fluid. The buffer layer preferably includes a protective fluid (either a gas or a liquid) between the nozzle and the conductive fluid. The protective fluid preferably has a density lower than a density of the conductive fluid. The nozzle optionally includes a porous region wherein the boundary layer of protective fluid is created through the porous structure of the nozzle. Alternatively, the nozzle may include at least one passageway through which the boundary layer of protective fluid is created upstream and proximate a face of the nozzle.

The flow of the conductive fluid through the nozzle may be enhanced by coating at least a portion of the nozzle with a solid layer of an easily wettable material prior using the nozzle and heating the object during use to at least a melting point of the easily wettable material.

A high-momentum, annular fluid jet may optionally be aimed substantially against a direction of flow the conductive fluid through the at least one nozzle. The high-momentum, annular fluid jet pinches the conductive fluid through the at least one nozzle thereby reducing the area through which the conductive fluid passes through the at least one nozzle.

According to another embodiment, the present invention features an apparatus for forming droplets. The apparatus includes at least one nozzle, a transformer including at least one AC magnetic core and at least two coils disposed around at least a portion of the at least one AC magnetic core, a magnetohydrodynamic (MHD) device including at least one permanent magnet, and a non-conducting, magnetic-permeable body. The non-conducting, magnetic-permeable body includes at least one loop having at least one inlet and at least one outlet fluidly coupled to the nozzle (preferably having a plurality of orifices). The loop is disposed within substantially the same plane as the two coils and defining at least one aperture through which the AC magnetic core is disposed. The loop forms a secondary loop of the transformer when the conductive fluid is disposed within the loop. The MHD device optionally includes at least one armature. A waveform generator is also preferably coupled to the two coils and creates a low current, high voltage waveform.

The apparatus may also include a first electrode contacting the conductive fluid prior to exiting the nozzle. The first electrode applies a first DC charge to the conductive fluid. A cooling column is preferably disposed after the nozzle for solidifying the droplets exiting the nozzle. The cooling column preferably includes a second electrode disposed proximate a region of the cooling column substantially opposite the nozzle. The second electrode has a DC charge opposite the first electrode.

According to yet another embodiment, the present invention features an apparatus and a method of fabricating a nozzle. A wafer is formed having an orifice layer and a support layer. The orifice layer has a thickness less than or equal to approximately two times of an orifice diameter of the nozzle. Next, a discharge well is formed substantially through the support layer and an inlet orifice is formed through the orifice layer such that the inlet orifice discharges into the discharge well.

The wafer may be formed by bonding the orifice layer directly onto the support layer, for example by plating the orifice layer to the support layer.

The discharge well and the inlet orifice may be formed by differentially etching the support layer and the orifice layer, lithography, or laser drilling. The orifice well preferably includes a diameter approximately ten times the orifice diameter. The method also preferably includes forming a plurality of inlet orifices. The adjacent inlet orifices are preferably spaced at least approximately ten times the orifice diameter. The inlet orifice also preferably includes an inlet edge radius no greater than approximately one-tenth of the orifice diameter.

According to yet a further embodiment, the present invention includes an apparatus and a method of facilitating the wetting of an object (preferably a filter or an orifice) through which a fluid passes. A coating is applied to at least a portion of a surface of the object with a solid layer of an easily wettable material prior to use of the object. Next, the object is heated during use to at least a melting point of the easily wettable material.

The coating may be formed using physical vapor deposition or chemical vapor deposition. Alternatively, the coating may be formed by creating a solution including a salt. A surfactant may be added to the solution. Next, a portion of the surface of the object is immersed in the solution. The object is then heated until the solution dissociates leaving behind the coating.

The present invention also features an apparatus and method of reducing the surface tension of a conductive fluid flowing through an object (preferably a filter or an orifice). A charge having a first polarity is applied to the conductive fluid prior to the conductive fluid passing though the object. The charge may be applied to the conductive fluid by contacting the conductive fluid with an electrode. Next, a second electric charge having a second polarity is provided downstream of the object. The second polarity being opposite of the first polarity. The second electric charge is preferably applied to a gas located downstream of the object.

### BRIEF DESCRIPTION OF THE DRAWINGS

These and other features and advantages of the present invention will be better understood by reading the following detailed description, taken together with the drawings wherein:

FIG. 1 is a diagram of a jet excitation device according to one embodiment of the present invention;

FIG. 2 is a schematic view of the jet excitation device with heating and filtering devices and a nozzle, according to one embodiment of the present invention;

FIG. 3 is a plan view of a liquid jet breaking up into a train of droplets.

FIG. 4 is a partial view of the body of the jet excitation device according to one embodiment of the present invention;

FIG. 5 is a cross sectional view of a jet excitation device according to one embodiment of the present invention;

FIG. 6 is another cross sectional view of a jet excitation device according to one embodiment of the present invention;

FIG. 7 is an electrical diagram of the transformer according to one embodiment of the present invention;

FIG. 8 is a is a diagram of the voltage through the transformer as a function of time according to one embodiment of the present invention;

FIG. 9 is a diagram of the current through the transformer as a function of time according to one embodiment of the present invention;

FIG. 10 is schematic diagrams illustrating the operating theory of the system for forming uniformly shaped spheres using a magnetohydrodynamic (MHD) system, in accordance with the present invention;

FIG. 11 is a schematic representation of the lines of flux and current flow in a system built according to the teachings of one embodiment of the present invention;

FIG. 12 is a schematic diagram of the Lorentz forces induced in the fluid core in accordance with the teachings of the present invention;

FIG. 13 is a perspective view of the discharge side of a nozzle plate of the present invention;

FIG. 14 is a sectional view of a well of the nozzle plate of FIG. 13;

FIG. 15 is an enlarged view of the circled area of FIG. 15;

FIG. 16 is a schematic sectional view of a jet exciter device coupled to a nozzle plate and cooling tower;

FIG. 17 is a schematic view of sheathing fluid being introduced upstream of two types of nozzles;

FIG. 18 is a sectional view of one core embodiment of a jet exciter device used with nozzle plates like those of FIG. 13;

FIG. 19 is a sectional view of another core embodiment with attached nozzle plates;

FIG. 20 is a sectional view illustrating a liquid-pinching nozzle for use with very high temperature liquids (e.g., T>2000° C.) and

FIG. 21 is a schematic diagram of one method of inducing flow of a conductive liquid filtrate through a filter or fine orifice using an electrical field to drag the fluid through the filter's fine pores.

### DETAILED DESCRIPTION OF THE PREFERRED EMBODIMENTS

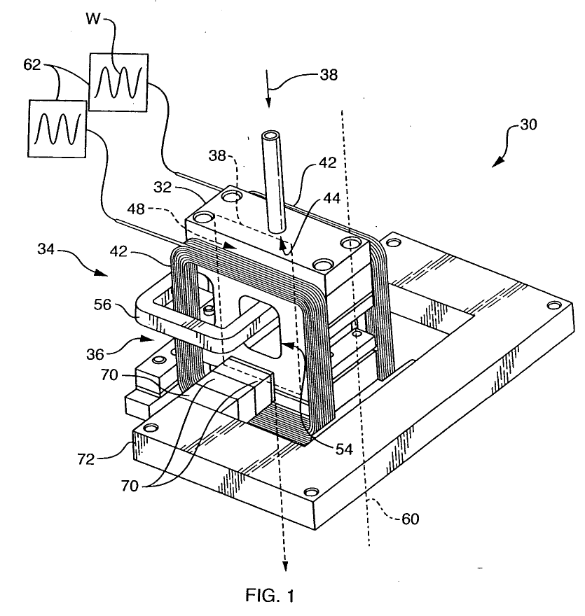

The present invention features a method and apparatus 30, FIG. 1, for advantageously controlling liquid jet breakup to produce stable, uniform size “monosphere” droplets, as well as reducing or eliminating satellite droplets through the use of specially-shaped jet excitation waves. The present invention will be described wherein the liquid jet is a liquid metal jet, but it will be appreciated that the liquid jet may also include any liquid 38 which is either conductive or which can be doped to make it conductive.

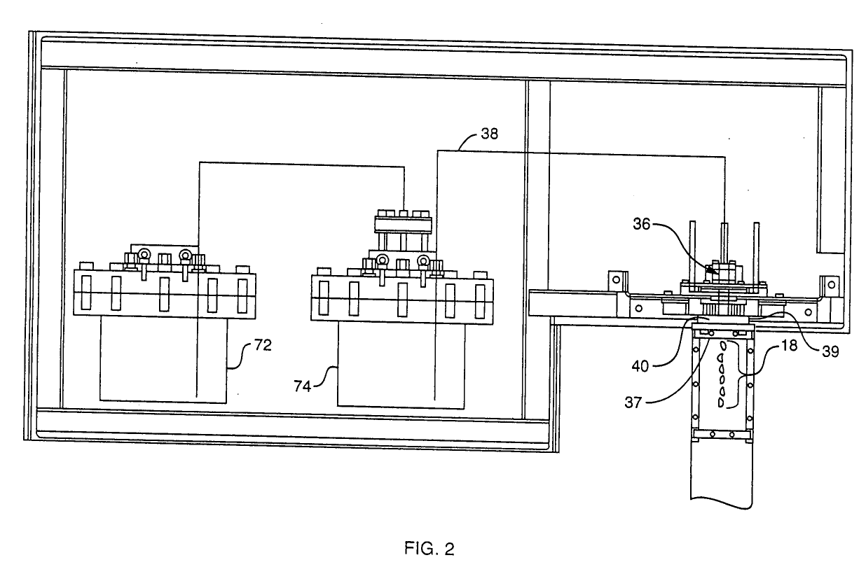

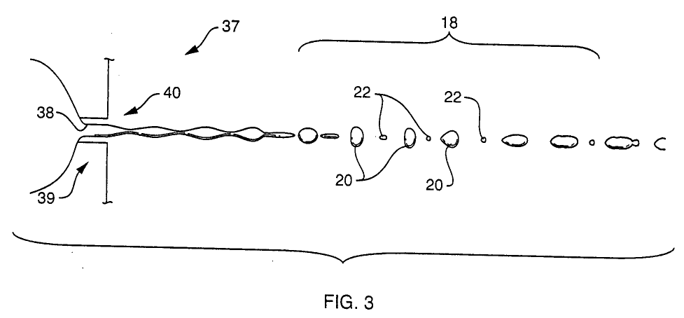

The basic physical process of the present invention is to exploit the instability of a liquid jet 37 acted upon by surface tension pinching. As will be discussed in greater detail hereinbelow, a stream of liquid metal 38, FIG. 2, is preferably melted, degassed and filtered in melting and holding crucibles 72, 74 as will be discussed in greater detail hereinbelow. The liquid metal 38 then enters a magnetohydrodynamic (MHD) exciter 36 that creates a pressure perturbation in the liquid jet's plenum 39 that ultimately encourages circumferential surface-tension pinching of the liquid jet 37, to rupture and form drops 18 as the liquid metal 38 exits the orifice 40. When the pressure perturbation is operated at the Rayleigh frequency, the liquid jet 37 becomes a train of equal, mono-sized spherical drops 18 as in FIG. 3. Altering the nozzle 40 diameter, as will be discussed in greater detail in the following section, can control the size of the drops 18. The basic virtue of this process, however, is the production of mono-size, spherical drops 18, or from them powder, in a very stable pattern.

Any liquid jet 37, FIG. 3, with a non-zero surface tension against its ambient fluid, given enough time or length, will break up into droplets 18. The breakup is caused by the phenomenon of surface-tension-pinching instability, which was first described by Lord Raleigh in 1873 as:
λ≅4.5 dⱼ d_{d}≅1.9 dⱼ
where:
λ=spacing between drops;
dⱼ=jet diameter; and
d_{d}=drop diameter.

The jet diameter dⱼ from a separated-flow orifice 40 of diameter d₀ is smaller than dₒ. The ratio of the jet diameter dⱼ and orifice diameter dₒ depends on the Reynold's number of the flow through the orifice 40. Typically the jet diameter (dⱼ) is approximately 84% of the orifice diameter (dₒ) because of the vena contracta.

Even when viscosity is added to the above equations, the basic equation still stands. It is worth noting that Rayleigh's equations are independent of the jet velocity Vⱼ (relative to earth), so the same pattern occurs in a liquid-metal jet moving at Vⱼ=5 m/s as in a water jet moving at 600 m/s, for example.

The breakup distance from the orifice 40 is affected by the magnitude and frequency of the exciting disturbance. Also, different magnitudes and frequencies of turbulence in the issuing jet 37, FIG. 3, will affect breakup distance. Moreover, other frequencies that are not harmonics of this fundamental frequency and magnitudes produce droplets 18 having non-homogeneous diameters d_{d} or sizes, and can lead to the production of “satellite” or mini-droplets 22 between the larger droplets 20 or can lead to drops of multiples (e.g., 2×) of the volume of drops formed at the fundamental frequency.

The droplet formation sequence 18 of a typical liquid jet 37 is shown in FIG. 3. A pressure is applied to a column of liquid 38 that is ejected through a nozzle 40. In the column of liquid 38, the interaction between surface tension, viscous, and inertial forces can form a droplet with a tail 16. The jet 37 then further breaks, by capillary instability, into a train of droplets 18, comprised of the primary droplet 20 and satellite droplets 22. The satellite droplets 22 are undesirable because they have a much smaller diameter than what was intended.

To form well-regulated, homogenous monosphere drops (i.e., each drop having a diameter approximately +/−2% of one another), to avoid the creation of “satellite” or mini-drops and to minimize the breakup length, the liquid jet 37 or flow 38 must be excited (i.e. a pressure disturbance must be introduced in the plenum 39, FIG. 2) at the jet's particular strongest-instability frequency. The jet's particular strongest-instability frequency is commonly referred to as the Rayleigh frequency, and may be written as:
f=Vⱼ/λ
where: λ is the distance between drops; λ=4.15 dⱼ from the Rayleigh theory. Thus, it is desirable to create a pressure disturbance in the plenum 39, FIG. 2, that causes a velocity disturbance in the liquid jet 37, according to Euler's equation, at the Rayleigh frequency in order to produce stable, mono-sized, spherical droplets.

One possible means of producing a high-frequency pressure perturbation in the plenum 39, is by using the Lorentz force (\vec{F}=\vec{J}×\vec{B}) where \vec{J} is current flowing in the liquid and \vec{B} are magnetic field lines through the liquid. This method usually requires electrical contacts with the liquid metal and requires high current for a strong jet perturbation. In the case of a liquid metal, the temperatures are typically high (e.g., 2000° C.) and the electrical contacts passing high current into the liquid metal can produce undesired electro-chemical reactions leading to short electrode life and liquid metal contamination. Thus, this method of direct contact is not desirable.

The present invention, in contrast, features a method and apparatus for producing a high-frequency, pressure perturbation at the plenum 39 without any electrodes contacting the liquid 38 nor the creation of any undesirable electro-chemical reactions. As will be explained herein below, this is accomplished by creating a current in the conducting liquid 38 by induction using transformer-like turns, ratioed to step up the current to the required high current in the conducting liquid metal, without needing high currents from the power source. By employing the Lorentz force (\vec{F}=\vec{J}×\vec{B}), the magnetohydrodynamic (MHD) apparatus, creates the pressure disturbance, preferably at the Rayleigh frequency. It is important to note that no electrical contacts with the liquid are needed, which is highly preferred especially at high temperature and with corrosive fluids (because of electro-chemical reactions and erosion).

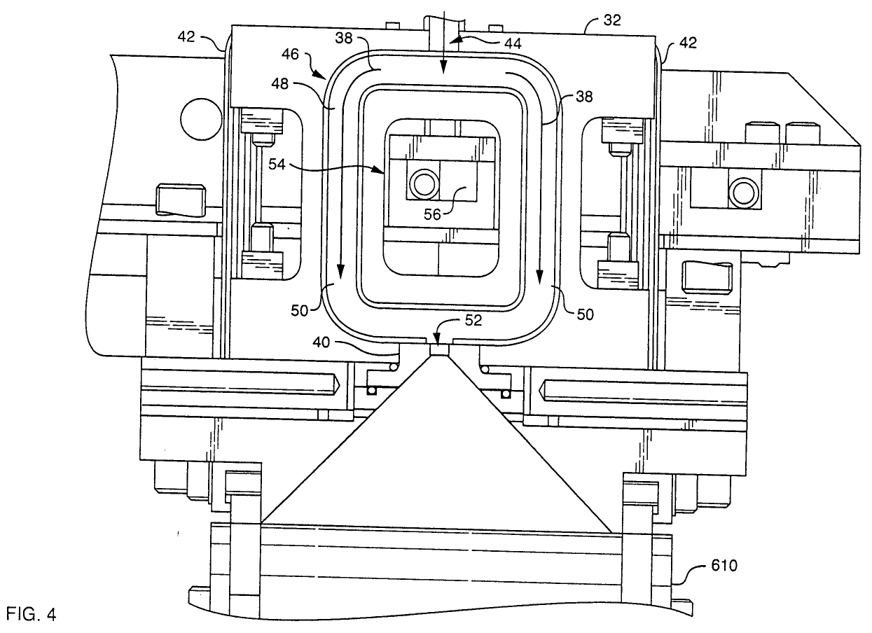

The jet excitation device 30, FIG. 1, includes three basic components, a body 32, a high-frequency transformer 34, and a MHD exciter 36. The liquid metal 38 flows from the filter, as described later, through the body 32 on its way to the nozzle 40 (FIG. 4), making the secondary loop 48 of the transformer 34. The transformer 34 transfers energy having a certain AC waveform from the coils 42 to the liquid metal loop 48 by magnetic induction. The armature 56 enhances the coupling between the primary 42 and the secondary coil 48. The MHD apparatus 36, comprised of permanent magnets 70 and armature 72, then transforms this current into a pressure disturbance, by means of the Lorentz phenomenon (preferably at the Rayleigh frequency), which serves to control the breakup of the liquid jet into regularly-sized droplets.

The body 32, FIG. 4, should be made from a non-conducting, magnetic-permeable material and includes one or more inlets 44 through which the liquid metal 38 flows from the filter and heating system (discussed herein after) and enters a cavity 46 forming one or more loops 48 having two or more fluid pathways 50. The fluid pathways 50 join, preferably opposite the inlet 44, whereby the liquid metal 38 enters one or more outlets 52 having one or more nozzles 40. One or more openings or apertures 54 are disposed within the body 32 within a central region of the loop 48 and are sized and shaped such that an AC magnet core 56 (discussed below) may be disposed through it.

The transformer 34, FIG. 1, includes one or more AC magnetic cores 56 that are disposed through the port 54 in the body 32 of the non-conducting, non-magnetic material. Two or more coils 42 are wound or looped around the AC magnetic core 56 and are disposed such that the plane of each of the coils 42 is substantially in the same plane as the plane of the flow-passage loop 48 in the body 32. The specific materials and dimensions of the coils 42 and AC magnetic core 56 will depend on the particular conducting liquid 38 as well as the desired drop size, and will be discussed in greater detail hereinbelow.

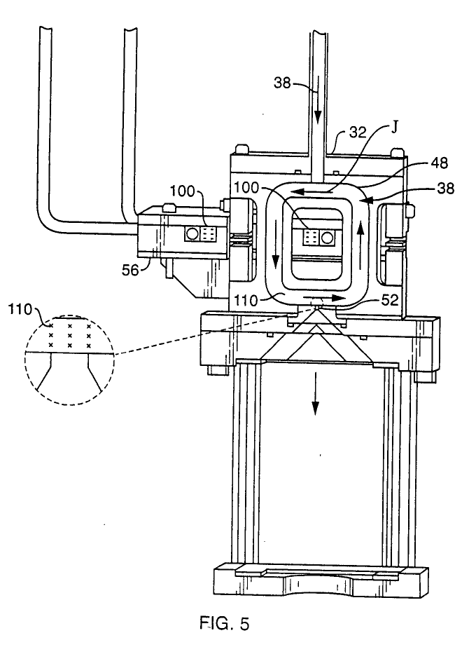

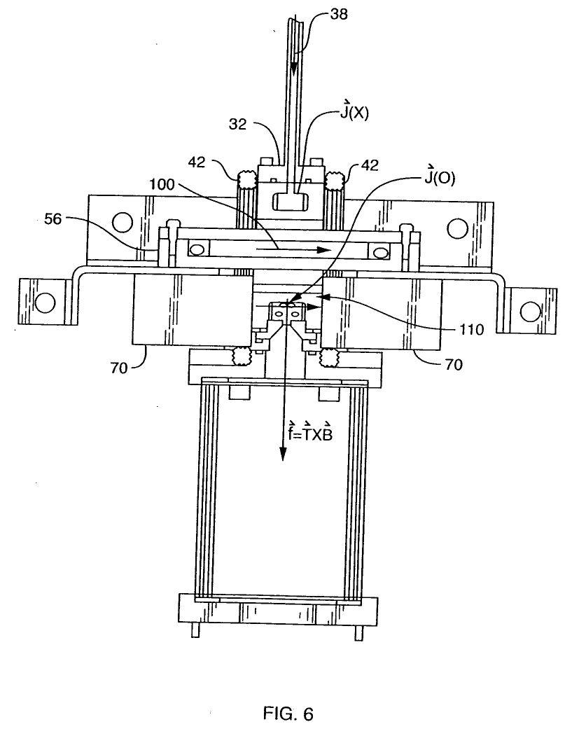

The coils 42 and AC magnetic core 56 act as the primary of the transformer 34, with the loop 48 of conducting liquid 38 acting as a shorted secondary. A waveform W, having low current and high voltage, is created by a waveform generator 62 and is applied to the coils 42. As shown in FIG. 5 and FIG. 6, this creates a magnetic field B that is aligned with the magnetic field 100 of the AC magnetic core 56 through the loop 50. As a result, a current, J, of N times the primary current in the coils 42 is induced in the loop 48 of the conducting liquid 38, where N is the ratio of the number of primary turns of the two coils 42 to the liquid loop 48 (usually one). Because the current J is induced through a transformer 34, it can only be an AC current. Thus, the transformer 34 transfers a high current at low voltage into the liquid loop 48 without the need for electrical contacts with the conducting liquid 38.

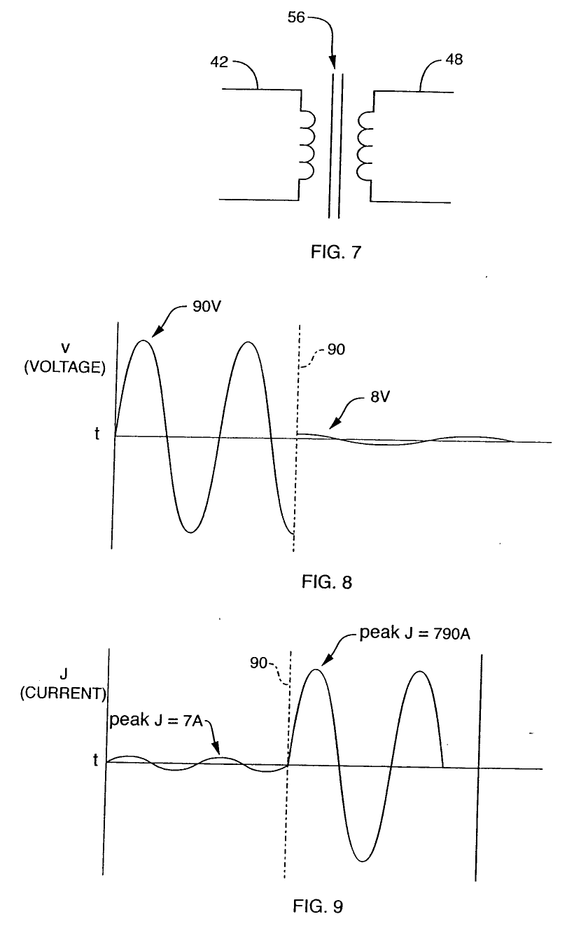

FIGS. 7-9 illustrate the induction of the current from the coils 42 into the conducting liquid 38. The dotted line 90 in FIG. 8 and FIG. 9 represent the location of the AC magnet core 56. As can be seen in FIG. 8 and FIG. 9, the voltage in the coil 42 is relatively high (e.g., ≈90V), whereas the current is relatively low (e.g., ≈7A). At the point where the coil 42 and AC magnetic core 56 intersect 90, energy is transferred into the conducting-liquid loop 48. As a result, the liquid loop 48 has a relatively low voltage (e.g., ≈8V), and a relatively high current (e.g., ≈790A).

The example MHD exciter 36, FIG. 1, FIG. 5 and FIG. 6, includes a permanent magnet 71 and an armature 70 creating a DC magnetic field 110 that is disposed perpendicular to the flow of the liquid metal 38 (which has the AC current J) proximate the outlets 52.

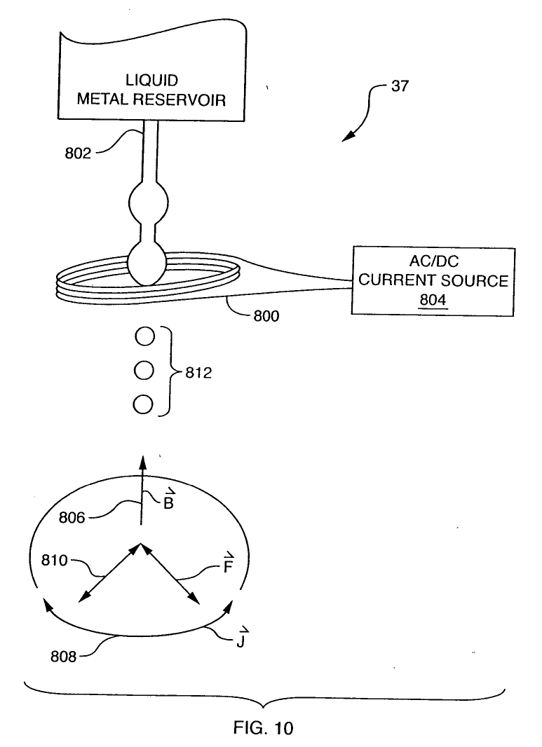

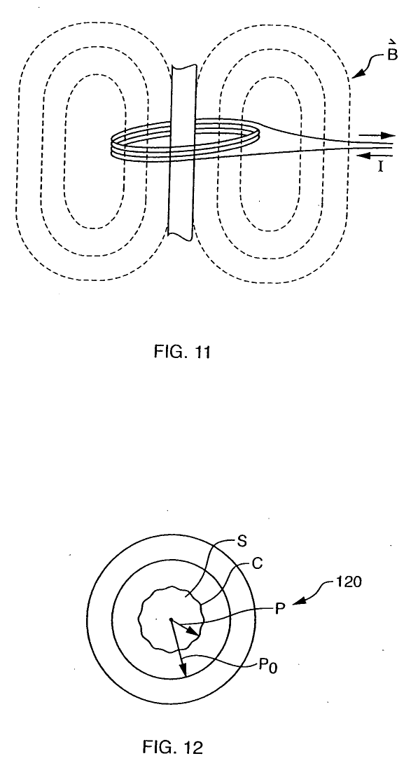

In addition to the means described above, a direct means of magnetohydrodynamic perturbation is also proposed. In this alternate means, MHD perturbation pores are created within the jet itself. A coil of wire 800, FIGS. 10 and 11, is provided at or below the breakup point of a liquid metal jet 802. Direct and alternating currents 804 are superimposed onto the coil 800. The direct current creates an axial magnetic field 806 and the AC current induces AC eddy currents 808 in the liquid jet, in the tangential direction. An MHD force is generated in the jet in the radial direction 810 as the cross-product of the field and the current. This MHD force generates a pinching disturbance, which serves to control the surface-tension driven breakup of the liquid jet into regularly-sized droplets 812 when the AC current is driven at the Rayleigh frequency.

At the center of the coil, 800:
\vec{B}≈nIμₒ\hat{z}
\vec{B}=\vec{B}_{DC}+\vec{B}_{AC}=n_{DC}I_{DC}μₒ\hat{z}+n_{AC}I_{AC}μₒ\hat{z}
where: I is the current in the coil, with alternating and direct components, I_{AC} and I_{DC} respectively,
μₒ is the permeability of free space,
\hat{z} is the direction coaxial with the jet,
\vec{B} is the magnetic field induced by I, with alternating and constant components, \vec{B}_{AC} and \vec{B}_{DC} respectively.
n refers to the number of turns in a coil, where n_{DC} are the number of turns carrying a direct current,
Subscripts ρ, φ and \hat{z} will be used to denote the radial (ρ, 180), tangential (φ, 808), and axial (\hat{z}, 806) components of vectors in a cylindrical coordinate system where the z axis is coaxial with the liquid jet, 802, in FIGS. 11 and 12.

If, as in FIG. 11, only one coil is used and it carries both AC and DC currents, then n_{DC}=n_{AC}=the number of turns of the coil. For the sake of the derivation, separate coils superimposing a magnetic field upon each other are assumed (n_{AC}=n_{DC} is not necessarily true).

Faraday's Law in integral form can be used to derive induced currents in the liquid jet 802. The jet 802 is approximated by a cylindrical perfect conductor passing through the center of the coil 800 with radius ρₒ.
Faraday's Law in Integral Form:

$${∮}_{C} {E}^{>} \cdot ⅆ {l}^{>} = - {\int }_{S} \int \frac{\partial {β}^{>}}{\partial t} \cdot ⅆ {S}^{>}$$

where: E^{>} is the time-varying Electric Field,
l^{>} is a vector defined along Contour C
t is time
B^{>} is the magnetic field

S=πρ² is defined as a concentric circular area with radius ρ and circumference C, C=2πρ. These parameters are illustrated in FIG. 12, which depicts a cross-section of the jet in FIG. 11.

Assuming a harmonic waveform (or sum of harmonic waveforms) I_{AC}=Rₑ└Iₒe^{jwt}┐, Faraday's Law takes on a simpler form:

$${∮}_{C} {E}^{>} \cdot ⅆ {l}^{>} = - jω {\int }_{S} \int {B}^{>} \cdot ⅆ {S}^{>}$$

where j=\sqrt{−1}, w is angular frequency.

Simplifying for the case in FIGS. 11 and 12:

$${∮}_{C} {E}^{>} \cdot ⅆ {l}^{>} = - 2 πρ {E}_{ϕ} \\ - jω {\int }_{S} \int {B}^{>} \cdot ⅆ {S}^{>} = - jω {n}_{AC} {I}_{AC} {μ}_{o} {πρ}^{2}$$

$$2 πρ {E}_{ϕ} = - jω {n}_{AC} {I}_{AC} {μ}_{o} {ρ}^{2}$$

$${E}_{ϕ} = - \frac{jω}{2} {n}_{AC} {I}_{AC} {μ}_{o} ρ$$

Via the Lorentz force expression, a force f^{>} can be seen to be acting on the surface of the jet 37:

Lorentz Force Density
f^{>}=ρεₒ+J^{>}×B^{>}

J^{>}=σE^{>}, where σ is the electrical conductivity of the liquid jet, 802, and J^{>} is the current density in the jet. So,
J^{>}=σE_{φ}\hat{φ}

A pressure can then be defined at the surface of the cylinder by integrating the Lorentz Force density in FIG. 12.

$$P = {\int }_{0}^{{ρ}_{0}} {f}^{>} \cdot ⅆ {ρ}^{>} = {\int }_{0}^{{ρ}_{0}} σ {E}_{ϕ} {B}_{z} ⅆ ρ$$

$$P = σ {B}_{z} {\int }_{0}^{{ρ}_{0}} {E}_{ϕ} ⅆ ρ = σ {B}_{z} {\int }_{0}^{{ρ}_{0}} - \frac{jω}{2} {n}_{AC} {I}_{AC} {μ}_{o} ρ ⅆ ρ$$

$$P = σ {B}_{z} \frac{jω}{2} {n}_{AC} {I}_{AC} {μ}_{o} {\int }_{0}^{{ρ}_{0}} ρ ⅆ ρ$$

$$P = σ Bz \frac{jω}{2} {n}_{AC} {I}_{AC} {μ}_{o} {ρ}_{o}^{2} = - \frac{σjω}{4} {n}_{AC} {I}_{AC} {μ}_{o} {ρ}_{o}^{2} [ {B}_{z AC} + {B}_{z DC} ]$$

$$P = σ \frac{jω}{4} {n}_{AC} {I}_{AC} {μ}_{o} {ρ}_{o}^{2} [ {n}_{AC} {I}_{AC} {μ}_{o} + {n}_{DC} {I}_{DC} {μ}_{o} ]$$

This relation describes an induced pressure fluctuation at the surface of a liquid jet, created through magnetohydrodynamic effects induced by currents carried in one or more coils surrounding the jet.

As discussed above, the plenum pressure perturbation should be applied at the Rayleigh jet-instability frequency:
f≅Vⱼ/2.4 d_{d}≅Vⱼ/4.5 dⱼ
For Vⱼ=5 m/s, this means a perturbation frequency ranging from approximately 21 kHz for 100 μm particles to approximately 2.1 MHz for 1 μm particles. Although some details of the MHD exciter design change through this range, the design concept and performance remain similar. Any modifications necessary are within the knowledge of one skilled in this art.

In the range of 100 μm particles down to about 20 μm particles, requiring about approximately 21 kHz to approximately 105 kHz excitation, the preferred magnetic material for the AC magnetic core 56 include amorphous alloy ribbon materials or magnetic powder materials. In the range of particles of 20 μm to 1 μm diameter, frequencies up to approximately 2.1 MHz are required, and the preferred material for the AC magnetic core 56 include ferrite materials. Although, compared to amorphous materials, ferrites have lower saturation flux density (around 0.35 to 0.5 Testa (T) compared to 0.5 to 0.2 for amorphous or powder armatures) and lower Curie temperatures (200-250° C.) and their high resistivity allows them to have lower loss and to maintain their permeability to higher frequencies. To avoid excessive hysteresis loss, they should be operated at flux densities in the range of about 50 mT to 200 mT, and at temperatures near approximately 100° C. The lower flux density is not a problem because the flux density required in operation is inversely proportional to frequency. The 100° C. maximum operating temperature will require aggressive cooling, but that is not much different from what is required for the 150° C. maximum operating temperature of the amorphous material.

The excitation winding of the coils 42 may also need to be modified as higher frequencies are used, using finer-strand Litz wire. Litz wire is conventionally used at frequencies up to about 3-5 MHz. Thus, with a Litz-wire winding and ferrite cores, exciter operation is possible at frequencies high enough for 0.5 μm particles.

Most likely the heat transfer from the molten metal will dominate cooling demand, so one can ignore the exciter's power dissipation. However, by adjusting the drive voltage to the coil 42 to make the exciter's dissipated power match the energy loss from the liquid metal 38, the heat dissipation could keep the metal hot in the MHD exciter 36. Alternatively, external heating can be applied to the loop 50. Because the high-frequency armature 56 and the DC magnet 71 must be cooled to below their temperature limits, external heating of the body 32 will be necessary in practice.

Liquid droplets are commonly formed through fluid-shear atomization processes, followed by solidification to solid particles. Particles formed this way are not uniform in size, and may be irregularly shaped. They require many separation steps in order to isolate narrow-size-cut fractions smaller than 100 μm diameter. Particles smaller than 10 μm diameter are especially hard to produce.

However, it's explained herein above, it is possible to produce droplets smaller than 10 μm or diameter using Raleigh instability acting on a liquid jet. Such single jets (e.g., approximately 5 μm diameter), however, have very low productivity (mass output/unit time). A single jet producing 10 μm solder droplets (which later solidify into particles) and operating with a jet speed of 5 m/s, requires 15 days to produce 1 kg of particles. In contrast, 360 jets operating in parallel could produce 1 kg in 1 hour. As explained herein, an array of these 360 jets can be placed on a nozzle plate as small as 10 mm² in area through the use of micro-fabrication techniques.

Micro-fabrication for MEMS (micro-electro-mechanical systems) technology has recently started applying micro-fabrication techniques, originally developed for electronics, to other types of systems. As such, the field of microfluidics has developed, mostly in the context of pumps and lab-on-a-chip. The present invention uses micro-fabrication to make nozzle plates with jet arrays.

The constraints needed to develop stable liquid jets are well-known: a sharp orifice inlet edge, orifice spacing greater than 10 times the orifice diameter, and orifice bore length less than 2 times the orifice diameter. While conventional micro nozzles as small as 50 μm diameter are available commercially, the present invention features nozzles ≧0.5 μm fabricated by MEMs.

The present invention provides micro-fabricated nozzle plates incorporating arrays of orifices. These plates combine the precision achievable in the applications of engineered orifices with the jet parallelism (e.g., 0.01 radians) typical of micro-devices and micro-fabrication.

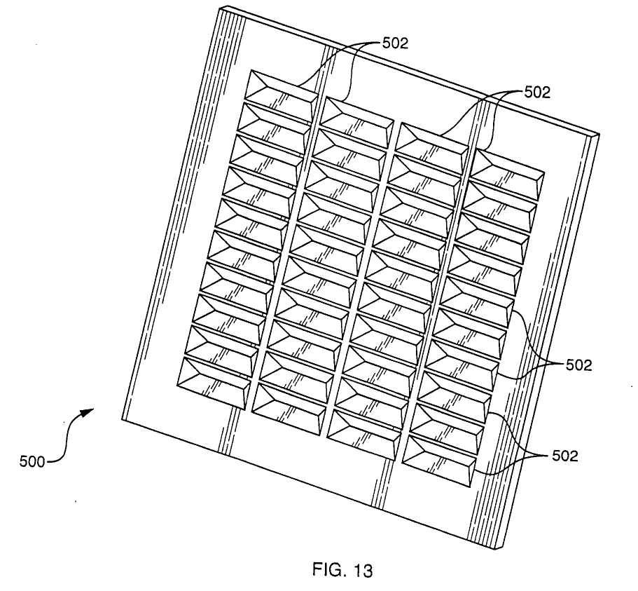

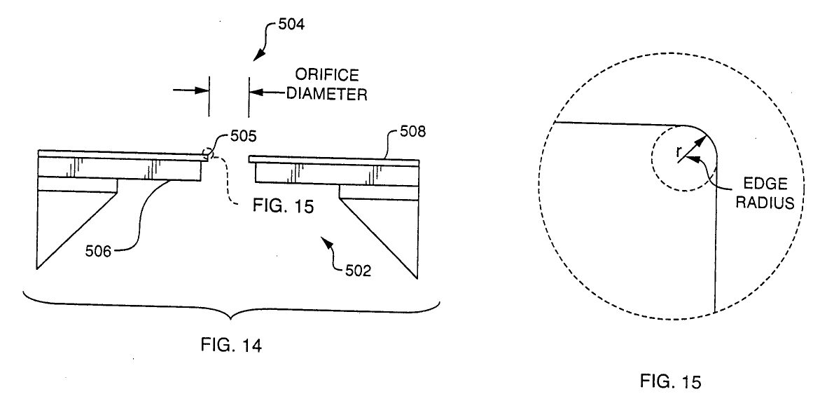

The present invention provides an array of multiple, orifices 504 (FIG. 13 and FIG. 14) packed into a micro-fabricated nozzle plate 500. The nozzle plates 500 are preferably used in conjunction with the MHD jet-excitation device (FIG. 1) discussed previously, although this is not a limitation of the present invention unless otherwise specifically claimed. The orifices 504 are intended to generate jets, which in turn generate droplets for powder manufacture. The large number of orifices in these nozzle plates 500 enables a commercially-practical processing throughput.

The present invention provides an efficient and high-productivity means for generating precise, mono-sized (e.g., ±2% in diameter) liquid droplets of sizes from about 1 μm to 100 μm, which are normally difficult to produce by other atomization processes because of the small fraction of particles generated in this small-size range and the need for subsequent classification for a narrow size cut. By fabricating all of the orifices 504 in the array the same size to approximately ±20% the diameter of the orifice (˜±0.01 μm precision for a 0.5 μm dₒ), the droplets generated by the present invention, (i.e., with a pressure perturbation generated by the Jet Excitation Device 30, FIG. 1, and using the nozzle plates 500 described herein) can be essentially mono-sized to approximately ±2% diameter precision.

Those skilled in the art will recognize that a broad variety of materials and methods can be used in the micro-fabrication of such plates 500. The process beginning with a wafer preferably of an etchable material such as silicon, Alternatively, dielectric materials such as silicon dioxide, silicon nitride or alumina are preferred for applications that apply charge to the jets formed with these orifice arrays.

The plate 500 (FIG. 13), includes a plurality of wells 502, each having one or more generally cylindrical orifice(s) 504 (FIG. 14). The number and arrangement shown are for illustrative purposes only preferably wells 502 and orifices 504 are formed in the wafer as follows: large holes (e.g., approximately 10× the orifice diameter), each forming a portion of a well 502, are cut nearly through the thickness of the wafer of a block-like starting material. This leaves a thin membrane through which the array of orifices 504 is cut from the other side of the wafer. The wells 502 and orifices 504 of several orifice plates 500 can be produced simultaneously from the same wafer. The original wafer is then cut into individual nozzle plates 500 (similar to the chip-fabrication process of dicing the wafer to create individual dies, which are then mounted and put to use in electronic systems).

One method of forming the nozzle plate 500 according to the present invention is to use lithography and a series of etches on a “system-on-insulator” (SOI) wafer composed of a layer of dielectric insulator, such as silica, bonded between two semiconductor layers of materials, such as silicon. A cross-section of one of the wells 502 and an orifice 504 from this process can be seen in FIG. 14. Here, a silicon nitride layer 508 is shown plated on the orifice inlet, providing wear resistance, chemical inertness, and a controlled orifice bore length and edge radius, 505. As discussed above, although only one orifice 504 is seen in cross section, many more may be formed in each well 502. FIG. 13 shows the large discharge-side wells 502 etched in a completed die. The jetting orifices 504 are at the bottom of these large wells 502, although they are not visible at this scale.

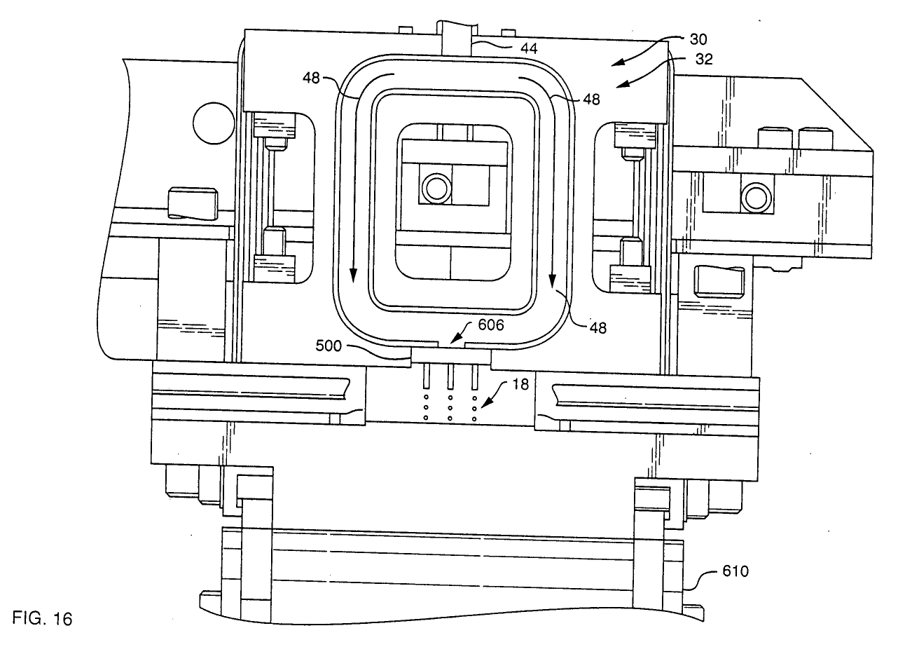

The nozzle plate, shown as block 500 in FIG. 16, is coupled to a fluid path 48, and a core 32 of a jet exciter device 30. The path 48 has an outlet 606 which feeds liquid to the nozzle plate 500. Jets of fluid are formed exiting plate 500 which then become droplets 18. A cooling column 610 may be used to solidify the droplets.

Although silicon-based fabrication processes are currently preferred to form these multi-orifice-array nozzle plates, a broad variety of alternative materials (e.g., silica, diamond, alumina and zirconia), may be substituted. Similarly, laser-drilling or other processes may be substituted as alternate means of fabrication.

The orifice arrays have the inherent capability of creating fluid jets, just as any other orifice might. The fluid processed is not limited to single-phase liquids, but may also be a gas, a plasma, or a multiphase mixture, such as oil and water or a solid and liquid such as solid particles and water. These jets can be broken up, as above, to form drops 18 that result in solid spheres after cooling to solidify.

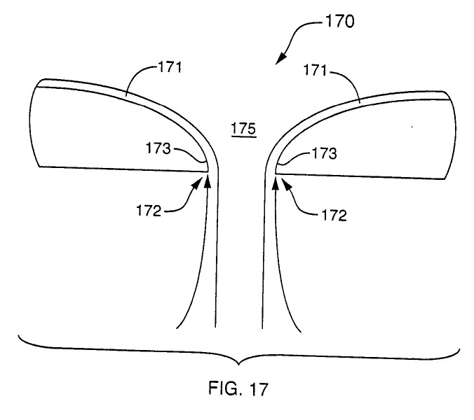

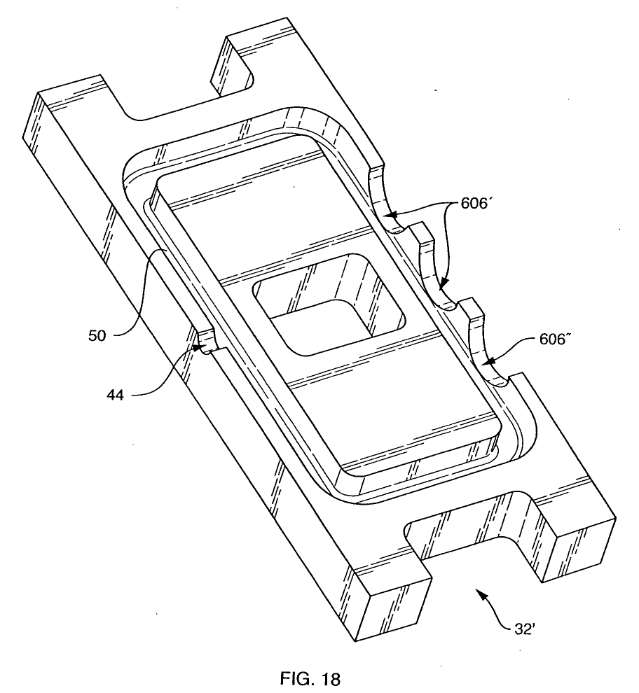

The present invention may include collinear orifices in stacked nozzle plates, supplied by fluidic channels 171 within the micro-nozzle, to apply sheath layers on the jets formed in these arrays, FIG. 17. Rayleigh breakup of these sheathed jets will create coated droplets or coated particles after solidification. Several concentric coatings can be formed on a solid particle in this way. The sheath layer may also be used to protect the nozzle from very hot and/or corrosive liquids.

The present invention allows the cooperating nozzle plates, together with the Jet Excitation Device 30 (FIG. 1), to produce a large number of coated droplets 18 and solid particles that are uniform in size ranging from approximately 1 to approximately 1000 μm diameter.

The formation of particles containing precipitated solute or solutes from droplets 18 of solution may be effected by passing the solution through the nozzle plates 500 and then drying or lyophilizing them. Porous particles may be created in this fashion. These in turn may be shrunk to much smaller size by melting the porous particles in a hot fluid, then cooling, to form less-porous or solid microspheres by the condensing action of the droplet's surface tension. This process is explained in greater detail in pending U.S. Provisional Patent Application Ser. No. 60/652,869, filed Feb. 15, 2005, which is fully incorporated herein by reference.

The core 32 of magnetohydrodynamic (MHD) jet exciter device 30, as seen in FIG. 16, includes an input channel 44 coupled to the fluid path 48 (FIGS. 1 and 3) which splits into two-branch liquid lines converging at the outlet 606, feeding the nozzle plate 500. The outlet 606 may be a single hole 606 or alternatively may include multiple outlets 606 as explained herein below. Liquid exits the hole 606 and contacts the nozzle plate 500, passing through orifices 504 to form a plurality of jets equal in number to the number of orifices 504. The jets, as described previously, are broken into droplets 18 and cooled to form solid spheres.

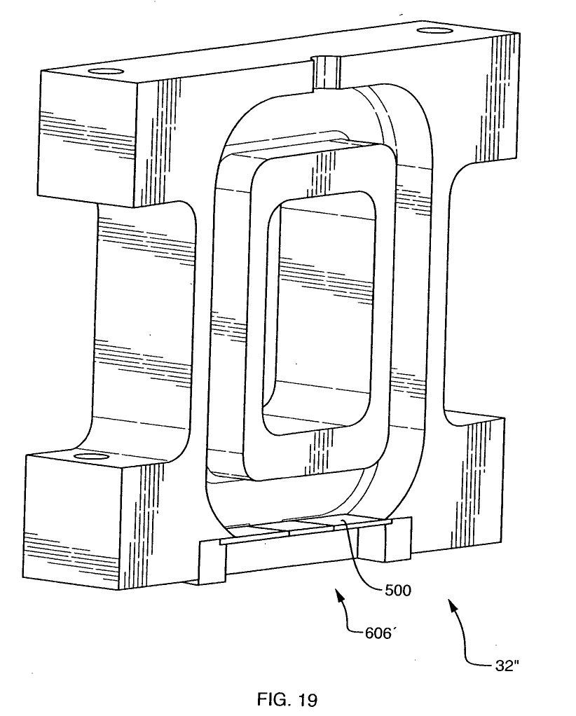

Alternatively, the core 32 may be replaced with core 32′, as seen in FIG. 18 (where like numerals represent like parts). The outlet of the core 32 may have a plurality of holes 606 (rather than one), each respectively in fluid contact with a nozzle plate 500. This allows a single MHD jet-exciter device 30 to handle the flow rate of a liquid, such as liquid metal, through a number of individual nozzle plates 500 each having a multitude of orifice 504. Because the jets formed via each of the nozzle plates 500 must be emitted into and cooled in a cooling tower with a controlled atmosphere (usually N₂, Ar or He), the employment of several nozzle plates 500 discharging into the cooling tower proportionally reduces the cost of the cooling section of the monosphere-production apparatus. Likewise, one liquid-metal-supply system comprised of: melter, metal cleaner/degasser, jet exciter and pressurized plenum can service multiple nozzle plates 500 thereby greatly reducing the cost of the liquid metal supply system.

Alternatively, as seen in FIG. 19, a core 32 may include one large hole 606 fluidly coupled to a plurality of nozzle plates 500 (three in the illustrative embodiment), which allow the formation of jets and droplets 18 as discussed above. For some applications of metal or other powders, a specific size distribution is wanted (e.g., for contemporary solder paste for surface-mount electronic soldering). The wanted distribution can be approximated adequately by mixing mono-sized microspheres.

The specified mixture can be fabricated directly, without after-mixing, by supplying different orifice 504 sizes in the one or more nozzle plate 500. The sum of the open areas of the orifices 504 of one size determines the mass per unit time produced by that size. So too for the other sizes. All are fed liquid metal at approximately the same pressure, so the jet velocity through all of the orifices 504 will be approximately the same. Thus the mass fractions of the resulting mixture are proportional to the total open area of the several orifice 504 sizes:

$$\begin{matrix}{M}_{T} = {M}_{1} + {M}_{2} + {M}_{3} - - - - {M}_{n} \\ = {V}_{j} Δ t {{\sum }_{1}}^{n} An = {( 2 Δ p / ρ )}^{1 / 2} Δ t {{\sum }_{1}}^{n} An\end{matrix}$$

where: M_{T}=total mass produced in Δt
Mₙ=mass produced of one size
Vⱼ=common-velocity of all jets
Δt=run time
An=total open area of n size orifice
n=orifice type number
Δp=pressure difference across orifice
ρ=liquid density

for various applications, there is a need to form well-configured jets of fluid. Unfortunately, the jet-forming fluid may attack the nozzle by chemical reaction (e.g., corrosion) and by erosion (e.g., abrasion by particles included in the jet-forming fluid) by melting and by cavitations in certain cases. In the particular case of chemically very active, high temperature liquid-metals, e.g., liquid iron (LFe), the potential of chemical attack, upon the nozzle material and subsequent degradation of the nozzle shape, is very serious. As explained herein above, in most applications, the contour of the nozzle is critical to the formation of a stable, well-conFIGured jet. Jet stability is essential to prevent the jet from disintegrating stochastically by the action of turbulence forces and by atomization caused by shear between the jet and its surrounding environment.

For creating well-configured jets, the fully-separated type of nozzle is often preferred because the jet is not affected by shear stresses in the nozzle bore, the pressure drop across the nozzle is minimum (merely the Bernouli pressure drop Δp=ρVⱼ²/2), and the jets are all precisely parallel if the entry surface is perfectly flat. It is well known from extensive experience with high-velocity waterjets and abrasive waterjet cutters, that the sharp-edge nozzle must have a very well-defined inlet edge in order to produce a high-quality jet. For example, the inlet edge of a jewel waterjet nozzle often is carefully polished to be axisymmetric and to have a specific radius (e.g., 2.5 μm claimed by Microlap Technologies™). Other types of nozzles are not separated at their entry, but the contour of the nozzle, particularly its axisymmetry, is critical to forming a well-configured jet.

As discussed above, the jet-forming fluid can be very corrosive and/or erosive to the nozzle material. In such cases, the nozzle contour can degenerate too rapidly for practical use. The result is a poorly-formed jet subjected to instability and atomization. In many cases, the jet-forming fluid is a liquid which is at a high temperature and/or corrosive and/or erosive fluid. Also, there are some cases where a highly-corrosive and/or erosive gas may attack the nozzle.

In order to make the use of such nozzles practical when using the nozzle with such fluids, some means must be employed that separate the nozzle material from the destructive fluid. Two known approaches have been reported in the literature and have been patented by Couch and Dean, U.S. Pat. No. 3,641,308 and by Katz, U.S. Pat. No. 5,921,846, which are both incorporated herein by reference.

For passing liquid iron (LFe) jets through the nozzle, means to protect the nozzle are essential because LFe is so chemically active that it will rapidly, as discussed earlier, reduce the nozzle material in times too short to make the nozzle practical, even when the nozzle is formed of superior ceramic, such as Al₂O₃ (sapphire) or ZrO₂. A more severe example, is liquid tungsten (LW) at 3600° C., which no known nozzle material can withstand. It might be possible to form such liquid metal jets by fluid dynamic means.

According to the one embodiment, the present invention shields the critical inlet lip of the fully separated nozzle 170, FIG. 17, with a boundary flow of gas or liquid 171 across the nozzle inlet plane and over the lip 172. For example, a nozzle 170 forming a jet of LFe could be protected, as illustrated in FIG. 17, with a layer of liquid silicon dioxide (LSiO₂). Because the LFe has a high density (ρ≅7800 kg/m³) at 1800° C. and LSiO₂ has a density of 2950 kg/m², the LFe will tend to centrifuge away from the sharp lip 173 of the nozzle 170 where streamline curvature is very high. Accordingly, the present invention features a stable layer of low density-shielding fluid 171 that covers the critical inlet edge 172 of the nozzle 170.

If the shielding fluid is a liquid, it will form a sheath on the jet emerging from the nozzle. This sheath could have a beneficial or a detrimental effect on jet stability, depending upon the characteristics of the two fluids. If the sheath is a gas, it should have no influence on jet stability. In fact, for low-density liquids, and if the gas were very low density, it could have a benign impact on the jet stability. For LFe or other metals, the gas sheath would have negligible effect because of the high density of LFe, and its high surface tension.

As seen in FIG. 17, a sheathing layer 171 is injected upstream, and on the face of, the nozzle 170, for example through a porous, annular section (e.g., formed of porous Al₂O₃). An orifice formed entirely of high-velocity liquid will behave similarly to the water-constricted plasma accelerating nozzle of Couch and Dean (U.S. Pat. No. 3,641,308). The annular nozzle 170 may be used for an annular flow of liquid or gas such as water or N₂ in order to serve as a fluid nozzle to form a jet of very high-temperature metal (e.g., W at 4000° C.). The nozzle 170 may be formed in a nozzle plate 500 which includes a fluid path 174 through which the constricting fluid 706 is passed, preferably at high pressure (and directed at a proper angle to the jet so as to oppose the pressure). The constricting fluid 706 impinges on the liquid metal to form a jet 708 exiting the liquid “nozzle” 170. If there are multiple orifices 170 in a nozzle plate 500, the same or different fluid paths 171 should extend to each orifice 170 to provide the necessary constricting and sheathing fluid (e.g, the stacked-plate nozzle of FIG. 17).

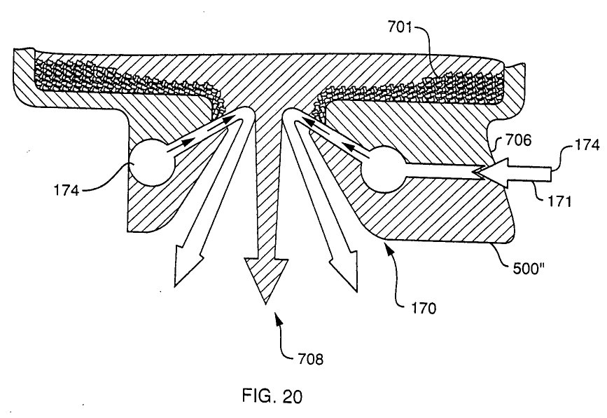

The present invention thus shields the critical inlet edge 172 of a fully separated nozzle 170, or the entire surface of the non-separated nozzle 170 with a gas or low-density fluid 171 (relative to the jet-forming fluid) by injecting said shielding flow 171 upstream of the nozzle entrance or by using a high-velocity liquid constricting and shielding flow to form a liquid “nozzle”. Accordingly, deleterious attack by the jet fluid on the critical geometry of these nozzles 170, which strongly influences jet stability and configuration, can be prevented. Critical to the sheathing concept (FIG. 17) is that the sheath fluid must have a lower density than the primary jet-forming fluid so that the sheath flow is stable over the convex contour of the nozzle wall. That is except in the case of the liquid “nozzle” (FIG. 20) where the shielding/constricting fluid density is not of primary concern.

The jets formed may be high-temperature liquid metals or an abrasive-loaded slurry 175. The nozzle sheathing for the high-temperature liquid metal jets 170 may be one that preferably does not interact with the nozzle 170 or the liquid material 175 of the jets. It can be a gas layer, such as He or Ar, or a liquid, such as liquid ceramics, for example, but not limited to, SiO₂ or glass or a benign metal or any other liquid of lower density than the liquid forming the jet. The jet may include any abrasive, such as SiC, garnet, carried in either a liquid or a gas flow. The nozzle may be a metal, such as Inconel, or a ceramic, such as Al₂O₃, sapphire, or Zn₂O, or a graphite, BN (boron nitride), WC (tungsten carbide), or BC (boron carbide), etc. or may be a sharp-edged, fully-separated type, or an un-separated type. The jet fluid may be a liquid, such as water, a metal, a ceramic, or a slurry of solids carried in either a liquid or gas jet fluid.

The jet so formed may be broken into a train of drops 18 as explained hereinbefore. Also, the jet itself of very-hot liquid (e.g., metals, ceramics, etc.) may be used for cutting and shaping materials according to the teachings of U.S. Pat. No. 3,641,308. When the fluid is such a slurry, the nozzle may form an abrasive slurry jet for cutting, surface cleaning, stripping and profiling.

It is also possible to form the “nozzle” from a fluid having sufficient momentum flux to pinch the jet thus forming, in essence, a liquid nozzle (FIG. 20). In the prior art, Couch and Dean (U.S. Pat. No. 3,641,308) employed such a fluid nozzle to pinch, and thus cause acceleration to the speed of sound of a very hot (15,000-25,000° C.) plasma flow creating a metal-cutting plasma jet.

By employing a high-momentum flux, annular water jet, aimed against the direction of the jet fluid flow (see FIG. 20), a “nozzle” of liquid can be formed. If water is the “nozzle” forming fluid, any liquid or gas at any temperature as far as is known can be formed into a jet. The plenum upstream of the “water nozzle” can be fashioned with cooled, metal walls to cause a “skull” 701, FIG. 20, of the solidified jet fluid to form and protect the walls.

The “penetration pressure” required to initiate flow through a non-wetted hole (e.g., orifice or filter pore) is given by Young's equation:
Δp=(4σ/dₒ)cos(θ)
Where: Δp=penetration pressure difference across orifice;
σ=liquid surface tension against the gas;
dₒ=diameter of orifice; and
θ=liquid contact angle (measured from solid surface)

For non-circular orifices, the same analysis pertains. It balances the pressure difference across the interface between liquid and gas against the surface tension force applied at θ to the surface through which the orifice penetrates. The maximum Δp occurs when θ=90°. Often the maximum is experienced to force a fluid through a hole.

TABLE 2
Orifice and Filter Penetration Pressures

| | | Δp_{fmax} [kPa (psi)] | | | | | |
|---|---|---|---|---|---|---|---|
| | σ | Filter Pore Size d_{f} | | | | | |
| Liquid | (mN/m) | 10 μm | | 1 μm | | 0.1 μm | |
| H₂O | 70 | 28 | (4.1) | 280 | (41) | 2800 | (410) |
| Sn | 600 | 240 | (34.8) | 2400 | (348) | 24,000 | (3,480) |
| Fe | 1800 | 720 | (104) | 7200 | (1040 | 72,000 | (10,400) |

Herein, Δp is shown as a function of dₒ and σ for various liquid/gas combinations (with θ the contact angle equal to 90°). For practical purposes, (e.g., testing filters,) θ=90° is assumed, which gives maximum Δp. Liquid metals have far higher surface tension than pure water (70 mN/m), with LFe (1800 mN/m) being among the highest at about 26× that of water. Consequently, the penetration pressure through a non-wetted 1 μm orifice is 40.6 psi for water and 1040 psi for LFe. The same equation holds for gas penetration into a liquid as for the same liquid penetration into the gas through the same size orifice.

High values of penetration pressure can lead to the impossibility of starting the flow through filters, micro-nozzles and other types of fine holes. A practical rule for filtering liquids before jetting through an orifice of diameter dₒ is that the filter pore size d_{f}<dₒ/10. Therefore, very small filter pores are required to form microspheres by the Rayleigh jet-breakup method. For example, in order to make 2 μm microspheres, dₒ≅1 μm and d_{f}≅100 nm. Forcing LFe through 100 nm filter pores requires a Δp=10,400 psi=720 bars=72 Mpa when the liquid does not wet the filter matrix.

Many devices with such pores cannot withstand application of this high penetration pressure. The filtering of liquid metals, such as Sn (σ=660 mN/m) and Fe (σ=1800 mN/m), through 100 nm filters requires penetration pressures, respectively, of 3,830 and 10,400 psi. Because of this need, the present invention arose and causes the liquid to wet (contact angle θ=0) the surface of the fine orifice so that surface tension will no longer resist the flow of the liquid through the orifice, hence reducing the penetration pressure to a negligible quantity.

There is one method which is known to be employed with aqueous liquids and fine filters to cause the liquid to penetrate fine pores. The material of the filter is made hydrophilic (i.e., wetted by water); then very little Δp is required to induce through flow. This method with water does not apply to liquid metal, however.

With LFe at about 1700° C., Al₂O₃ (e.g., sapphire), or ZrO₃ will be typical material of construction of the filter/orifice(s). LFe wets neither of these materials. So making the filter surface wettable with LFe is essential to form a dⱼ≅1 μm jet of LFe.

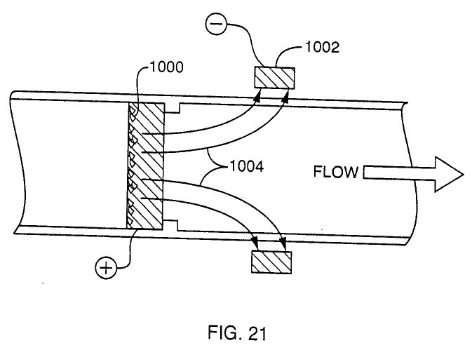

According to another, the present invention features a method and apparatus for making the surface of filters and orifices 1000, FIG. 21, and their plates wettable by most any liquid metal (LM). That is, to coat all surfaces with a thin layer (μm thick) of the solid of the same metal or the solid of a metal that the subject metal wets easily (e.g., Sn on Cu).

There are various means that serve this purpose. For example, physical vapor deposition (PVD) or chemical vapor deposition (CVD) might be employed at high vacuum, with some means to force the PVD or CVD vapor through the filter or through an orifice or through an array of orifices. To do this, would require establishment of a pressure drop across the filter to cause the metal vapor to flow through the filter or orifice in order to deposit a coating on all surfaces of passages through the filter/orifice. While this probably could be done, there is also one or more easier approaches.

One such approach involves obtaining a water-soluble salt of the metal such as for Sn: SnCl₂, Sn(OH)₂ or SnBr₄; for Au: aquaregia; for Cu: CuSO₄, CuCl₂ (in EtOH), Cu(NO₃)₂.6H₂O; for Ni: NBr₂, NiCl₂, NiI₂, NiSO₄; etc. For example, use SnCl₂ having a concentration of 0.5-50 g/L (20 g/L preferred). The filter or orifice plate is thoroughly soaked/immersed/coated in the aqueous solution of the metal's water soluble salt. It may be necessary to control concentration and pH in order to achieve complete wetting and/or employ a surfactant (complete wetting being defined as the solution coming into contact with all interior and exterior surfaces.) The element is then drained and heated, for example to approximately 400° C. (for SnCl₂—other metals will need different temperatures to decompose the salt, which must be chosen to decompose below the boiling temperature of the metal, e.g., SnCl₂'s Tdec=376° C., Sn boils at 2602° C.), in a non-oxidizing furnace until the compound dissociates leaving behind a coating of the metal. Then the element is cooled and assembled into the apparatus.

Upon heating the apparatus above the melting point of the metal (300° C. for Sn or 1550° C. for Fe) in order to implement good flow characteristics of the LM, the filter or orifice surfaces will be coated with the liquid metal. Under such circumstances, the surfaces that were coated (i.e., with the salt in the first step), when a pressure difference is applied across the pores or orifices, will be wetted by the permeating liquid with contact angle θ approaching 0. With such wetting, the liquid metal will seep through the pores onto the gas side. By spreading out across the rear face of the filter or orifice plate, the contact angle between the gas-liquid interface goes to ≅0, thereby, reducing the penetration pressure to ≅0.

In a further embodiment, the invention features a means whereby the surface tension of the liquid is reduced by an electrical charge placed on the jet LM interface with the gas. The presence of charge on a meniscus can change the effective surface tension or surface energy, lowering it from its intrinsic magnitude, and thereby lowering the orifice penetration pressure. For a parallel-plate charging apparatus with plate separation d, the change in surface energy γₑ caused by electrical charging is:
γₑ=1½ρₛV=½ρₛ²d/εₒ=½εₒE²d
where:
ρₛ is the surface charge density in C/m²,
V is an applied voltage,
εₒ is the permittivity of free space, 8.85×10⁻¹² F/m, and
Eₒ is the magnitude of an applied electric field at the interface.

The effective surface tension, σₑ, is the original surface tension σ₁ minus this change in surface energy:
σₑ=σ₁−γₑ

The pressure Δp required to initiate a jet in a dₒdiameter orifice is:
Δp=4σₑ/dₒ

Table 2 uses these equations to find the surface charge and electric field at the interface needed to reduce the penetration pressure of various fluids through a 2 μm orifice to approximately 2 psi.

TABLE 2
Charging to Reduce 2 μm Orifice Penetration
Pressure to 14 kPa(2 psi)

| | | | Electric Field |
|---|---|---|---|
| | Surface Tension | Surface Charge | At Surface |
| Material | mN/m | C/m² | V/m |
| Water | 70 | 5.28E−05 | 5.97E+06 |
| Tin | 560 | 1.56E−04 | 1.77E+07 |
| Iron | 1800 | 2.82E−04 | 3.18E+07 |
| With | | | |
| Surfactants: | | | |
| Water | 35 | 3.53E−05 | 3.98E+06 |
| Iron | 900 | 1.99E−04 | 2.25E+07 |

Liquid metals under strong electric fields have a tendency to form sharp cones, at whose apex the electric field is strong enough to cause ion emission. Our nano-microsphere process circumvents this by pressurizing the ambient gas. When the differential pressure across the orifice or filter is at a pressure greater than 14 kPa, a jet should form from the orifice when the liquid surface is sufficiently charged to reduce the penetration pressure below 14 kPa.

The initial jet diameter dⱼ is approximately equal to the orifice diameter dₒ where the initial jet velocity Vⱼ is controlled by the pressure differential across a sharp edge orifice when bore length in less than 1/10^{th} the orifice diameter. For example:
dⱼ≈dₒ;
Vⱼ²=2Δp/ρⱼ;
Where ρⱼ=density of liquid, Δp=pressure drop across the orifice.

With 7 kV placed on an electrode 400 microns from a liquid tin interface, the penetration pressure will be reduced, for a 2 micron orifice, from approximately 1.1 MPa to approximately 14 kPa, well below a tolerable 140 kPa (200 psi) supply pressure.

Thus, with the surface tension reduced by the surface charge, a tolerable pressure can push the liquid through the orifice, even one that is not wetted by the liquid.

This can be accomplished in a dielectric apparatus, with a dielectric filter 1000, FIG. 21. A conducting liquid is charged to one polarity and voltage via a submerged electrode. An electrode 1002 in the gas is charged to an opposite polarity through the application of a differential voltage. The electrode 1002 may be annular in shape and is placed downstream of the filter or orifice 1000.

There may be an additional electrical effect, which helps to pull the filtrate through a dielectric filter. A charge, illustrated by lines of electric field 1004, will be placed on the liquid surface as a consequence of the formation of the electric field between the downstream electrode in the gas and the liquid metal. Charge in the presence of the electric field will pull the liquid through the filter. Another way of looking at this is that the fluid and the electrode form a capacitor. The fluid is a mobile plate; the capacitor seeks to minimize the energy it contains, so the liquid moves toward the downstream electrode.

Still another method is to wet the filter with a liquid metal that will coat the surfaces. Then on starting the filter, the feed liquid metal will displace the liquid metal coating. For example, Al wets Al₂O₃. On starting, the filter is heated to a temperature equal to or greater than the melting temperature of Al (approximately 660° C.). Then pressurized Sn can displace the Al filling the filter's pores. The starting pressure drop will be small.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive nor to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

1. A method of forming droplets comprising the acts of:
providing a conductive fluid;
creating a current in said conductive fluid using induction;
creating a pressure perturbation in said conductive fluid using the Lorentz phenomenon; and
discharging said conductive fluid through at least one nozzle.

2. The method as claimed in claim 1 wherein further including creating said pressure perturbation in said conductive fluid using the Lorentz phenomenon at approximately the Rayleigh frequency of jet instability.

3. The method as claimed in claim 1 wherein said conductive fluid includes liquid metal.

4. The method as claimed in claim 1 wherein said conductive fluid includes a salt solution.

5. The method as claimed in claim 1 wherein said conductive fluid includes at least one solgel.

6. The method as claimed in claim 1 wherein said act of providing said conductive fluid includes doping a nonconductive material to create said conductive material.

7. The method as claimed in claim 1 wherein said act of creating said current in said conductive fluid using induction further includes inducing said current using transformer turns, ratioed to step up said current.

8. The method as claimed in claim 1 where said act of creating said pressure perturbation in said conductive fluid using the Lorentz phenomenon further includes using a magnetohydrodynamic (MHD) apparatus.

9. The method as claimed in claim 8 wherein said MHD apparatus includes at least one high-frequency transformer primary coil, a secondary coil formed from said conductive fluid, and a DC magnet.

10. The method as claimed in claim 1 wherein said act of creating said current in said conductive fluid using induction is performed after said act of discharging said conductive fluid from said at least one nozzle.

11. The method as claimed in claim 10 wherein said act of creating said current in said conductive fluid using induction includes the acts of:
providing at least one coil disposed at or below a jet breakup point of said conductive fluid;
applying an AC and a DC current to said at least one coil; and
passing said conductive fluid through said at least one coil.

12. The method as claimed in claim 11 wherein further including the act of applying said AC and said DC current to a first and at least a second coil, respectively.

13. The method as claimed in claim 11 wherein further including the acts of superimposing said AC and said DC current and applying said superimposed AC/DC current to a first coil.

14. The method as claimed in claim 1 wherein said act of creating said current in said conductive fluid using induction is performed prior to said act of discharging said conductive fluid from said at least one nozzle.

15. The method as claimed in claim 1 wherein said act of discharging said conductive fluid through said at least one nozzle further includes creating a buffer layer between said at least one nozzle and said conductive fluid.

16. The method as claimed in claim 15 wherein said act of creating said buffer layer further includes creating a boundary layer of protective fluid between said at least one nozzle and said conductive fluid.

17. The method as claimed in claim 16 wherein said boundary layer of protective fluid between said at least one nozzle and said conductive fluid includes a layer of protective fluid having a density lower than a density of said conductive fluid.

18. The method as claimed in claim 17 wherein said boundary layer of protective fluid between said at least one nozzle and said conductive fluid includes a layer of a protective liquid.

19. The method as claimed in claim 18 wherein said boundary layer of protective fluid between said at least one nozzle and said conductive fluid includes a layer of liquid silicon dioxide.

20. The method as claimed in claim 17 wherein said boundary layer of protective fluid between said at least one nozzle and said conductive fluid includes a protective layer of gas.

21. The method as claimed in claim 16 further including forming said nozzle of a porous material wherein said boundary layer of protective fluid between said at least one nozzle and said conductive fluid is created through said porous structure of said at least one nozzle.

22. The method as claimed in claim 16 further including forming at least one passageway through said at least one nozzle through which said boundary layer of protective fluid is created upstream and proximate a face of said at least one nozzle.

23. The method as claimed in claim 1 further including the act facilitating the flow of said conductive fluid through said at least one nozzle including, wherein said act includes:
coating at least a portion of said at least one nozzle with a solid layer of an easily wettable material prior using said at least one nozzle; and
heating said object during use to at least a melting point of said easily wettable material.

24. The method as claimed in claim 1 wherein said act of discharging said conductive fluid through said at least one nozzle further includes discharging a high-momentum, annular fluid jet substantially against a direction of flow said conductive fluid through said at least one nozzle, wherein said high-momentum, annular fluid jet pinches said conductive fluid through said at least one nozzle thereby reducing the area through which said conductive fluid passes through said at least one nozzle.

25. The method as claimed in claim 1 further including the act of applying a first DC charge to said droplets, wherein said droplets all have the same DC charge.

26. The method as claimed in claim 25 further including providing a region beneath said at least one nozzle having a second DC charge, said second DC charge being opposite from said first DC charge.

27. An apparatus for forming droplets comprising:
at least one nozzle;
a transformer including at least one AC magnetic core and at least two coils disposed around at least a portion of said at least one AC magnetic core;
a magnetohydroynamic (MHD) device including at least one permanent magnet; and
a non-conducting, magnetic-permeable body including at least one loop having at least one inlet and at least one outlet fluidly coupled to said at least one nozzle, said at least one loop is disposed within substantially the same plane as said at least two coils and defining at least one aperture through which said at least one AC magnetic core is disposed, whereby said at least one loop forms a secondary loop of said transformer when said conductive fluid is disposed within said at least one loop.

28. The apparatus as claimed in claim 27 wherein said MHD device further includes at least one armature.

29. The apparatus as claimed in claim 27 further including a waveform generator coupled to said at least two coils and creating a low current, high voltage waveform.

30. The apparatus as claimed in claim 27 wherein said AC magnetic core includes a material selected from the group consisting of amorphous alloy ribbon materials, magnetic powder materials, or ferrite materials.

31. The apparatus as claimed in claim 27 wherein said at least two coils include Litz-wire.

32. The apparatus as claimed in claim 27 further including means for maintaining the temperature of said conductive fluid within said body.

33. The apparatus as claimed in claim 27 further including a first electrode contacting said conductive fluid prior to exiting said at least one nozzle, said first electrode applying a first DC charge to said conductive fluid.

34. The apparatus as claimed in claim 33 further including a cooling column for solidifying said droplets exiting said at least one nozzle, said cooling column having a second electrode disposed proximate a region of said cooling column substantially opposite said at least one nozzle, said second electrode having a DC charge opposite said first electrode.

35. The apparatus as claimed in claim 27 wherein said at least one nozzle includes at least one nozzle plate including a plurality of orifices.

36. The apparatus as claimed in claim 35 wherein said one loop includes a plurality of outlets, wherein each of said outlets is fluidly coupled to a nozzle plate including a plurality of orifices.

37. The apparatus as claimed in claim 35 wherein said at least one nozzle plate includes a first nozzle plate having a plurality of first orifices having a first diameter and at least a second nozzle plate having a plurality of second orifices, wherein said first orifices have a different diameter than said second orifices.

38. The apparatus as claimed in claim 35 wherein said at least one nozzle plate includes a plurality of orifices having at least two different orifice diameters.

39. The apparatus as claimed in claim 27 wherein said at least one nozzle includes means for creating a boundary layer of a protective fluid between said at least one nozzle and said conductive fluid.

40. The apparatus as claimed in claim 39 wherein said at least one nozzle includes at least one passageway coupled to an interior surface of said at least one nozzle through which said protective fluid flows.

41. The apparatus as claimed in claim 27 further including an annular jet of a high-momentum fluid orientated substantially at said at least one nozzle and against a direction of flow said conductive fluid through said at least one nozzle, wherein said high-momentum, annular fluid jet pinches said conductive fluid through said at least one nozzle thereby reducing the area through which said conductive fluid passes through said at least one nozzle.

42. An apparatus for forming droplets comprising:
an inductor disposed proximate a conductive fluid, said inductor creating a current in said conductive fluid;
a magnetohydroynamic (MHD) device disposed proximate said conductive fluid, said MHD device creating a pressure disturbance in said conductive fluid; and
at least one nozzle in fluid communication with said conductive fluid, wherein said inductor and said MHD device generate a pressure perturbation within said conductive fluid prior to said conductive fluid exiting said at least one nozzle.

43. The apparatus as claimed in claim 42 wherein said inductor includes:
a transformer; and
a non-conducting, magnetic-permeable body including at least one loop having at least one inlet and at least one outlet fluidly coupled to said at least one nozzle and through which said conductive fluid flows, wherein said at least one loop forms a secondary loop of said transformer when said conductive fluid is disposed therein.

44. The apparatus as claimed in claim 43 wherein said inductor includes at least one AC magnetic core and at least two coils disposed around at least a portion of said at least one AC magnetic core.

45. The apparatus as claimed in claim 44 wherein said at least one loop of said non-conducting, magnetic-permeable body is disposed within substantially the same plane as said at least two coils.

46. The apparatus as claimed in claim 45 wherein said at least one loop of said non-conducting, magnetic-permeable body defines at least one aperture through which said at least one AC magnetic core is disposed.

47. The apparatus as claimed in claim 44 wherein said at least two coils include Litz-wire.

48. The apparatus as claimed in claim 43 further including means for maintaining the temperature of said conductive fluid within said body.

49. The apparatus as claimed in claim 42 further including a first electrode contacting said conductive fluid prior to exiting said at least one nozzle, said first electrode applying a first DC charge to said conductive fluid.

50. The apparatus as claimed in claim 49 further including a cooling column for solidifying said droplets exiting said at least one nozzle, said cooling column having a second electrode disposed proximate a region of said cooling column substantially opposite said at least one nozzle, said second electrode having a DC charge opposite said first electrode.

51. The apparatus as claimed in claim 42 wherein said at least one nozzle includes at least one nozzle plate including a plurality of orifices.

52. The apparatus as claimed in claim 51 wherein said at least one nozzle plate includes a first nozzle plate having a plurality of first orifices having a first diameter and at least a second nozzle plate having a plurality of second orifices, wherein said first orifices have a different diameter than said second orifices.

53. The apparatus as claimed in claim 51 wherein said at least one nozzle plate includes a plurality of orifices having at least two different orifice diameters.

54. The apparatus as claimed in claim 42 wherein said at least one nozzle includes means for creating a boundary layer of a protective fluid between said at least one nozzle and said conductive fluid.

55. The apparatus as claimed in claim 54 wherein said at least one nozzle includes at least one passageway coupled to an interior surface of said at least one nozzle through which said protective fluid flows.

56. The apparatus as claimed in claim 42 further including an annular jet of a high-momentum fluid orientated substantially at said at least one nozzle and against a direction of flow said conductive fluid through said at least one nozzle, wherein said high-momentum, annular fluid jet pinches said conductive fluid through said at least one nozzle thereby reducing the area through which said conductive fluid passes through said at least one nozzle.

57. An apparatus for forming droplets comprising:
a fluid source;
at least one nozzle coupled to said fluid source;
an AC current source;
a DC current source; and
at least one coil disposed proximate a breakup point of a fluid, said at least one coil coupled to said AC and said DC current sources.

58. The apparatus as claimed in claim 57 wherein said apparatus includes only one coil, wherein said AC and said DC current source are superimposed on said coil.

59. The apparatus as claimed in claim 57 wherein said apparatus includes a first and at least a second coil, wherein said AC current source is coupled to said first coil and said DC current source is coupled to said at least a second coil.

60. The apparatus as claimed in claim 57 wherein said at least one nozzle includes a nozzle plate including a plurality of orifices.

61. A method of fabricating a nozzle comprising the acts of:
forming a wafer including an orifice layer and a support layer, said orifice layer having a thickness less than or equal to approximately two times an orifice diameter of said nozzle;
forming a discharge well substantially through said support layer; and
forming an inlet orifice through said orifice layer such that said inlet orifice discharges into said discharge well.

62. The method as claimed in claim 61 wherein said act of forming said wafer includes bonding said orifice layer directly to said support layer.

63. The method as claimed in claim 62 wherein said act of bonding including depositing said orifice layer onto said support layer.

64. The method as claimed in claim 61 wherein said orifice layer includes silicon nitrite.

65. The method as claimed in claim 61 wherein said orifice layer includes a semiconductor material.

66. The method as claimed in claim 61 wherein said support layer includes a dielectric material.

67. The method as claimed in claim 66 wherein said dielectric material includes silicon dioxide.

68. The method as claimed in claim 66 wherein said dielectric material includes silicon nitride.

69. The method as claimed in claim 66 wherein said dielectric material includes alumina.

70. The method as claimed in claim 61 wherein said acts of forming said discharge well and forming said inlet orifice include differentially etching said support layer and said orifice layer.

71. The method as claimed in claim 61 wherein said acts of forming said discharge well and forming said inlet orifice include lithography.

72. The method as claimed in claim 61 wherein said acts of forming said discharge well and forming said inlet orifice include laser drilling.

73. The method as claimed in claim 61 wherein said act of forming said orifice well includes forming said orifice well with a diameter approximately ten times said orifice diameter.

74. The method as claimed in claim 61 wherein said act of forming said inlet orifice includes forming a plurality of inlet orifices, wherein adjacent inlet orifices are spaced at least approximately ten times said orifice diameter.

75. The method as claimed in claim 61 wherein said act of forming said inlet orifice includes forming said inlet orifice having an inlet edge radius no greater than approximately one-tenth of said orifice diameter.

76. A method of facilitating the wetting of an object through which a fluid passes comprising the acts of:
coating at least a portion of a surface of said object with a solid layer of an easily wettable material prior to use of said object; and
heating said object during use to at least a melting point of said easily wettable material.

77. The method as claimed in claim 76 wherein said object includes a filter.

78. The method as claimed in claim 76 wherein said object includes a nozzle.

79. The method as claimed in claim 76 wherein said act of coating said at least a portion of said object includes physical vapor deposition.

80. The method as claimed in claim 76 wherein said act of coating said at least a portion of said object includes chemical vapor deposition.

81. The method as claimed in claim 76 wherein said act of coating said at least a portion of said object includes the acts of:
creating a solution including a salt;
immersing said at least a portion of said surface of said object in said solution; and
heating said at least a portion of said surface of said object until said solution dissociates leaving behind said coating.

82. The method as claimed in claim 81 wherein said act of creating said solution includes adding a surfactant to said solution.

83. The method as claimed in claim 81 wherein said act of creating said solution includes dissolving said salt in acetone.

84. The method as claimed in claim 81 wherein said act of creating said solution includes dissolving said salt in an acid-water solution.

85. The method as claimed in claim 81 wherein said act of creating said solution includes dissolving said salt in a hydrocarbon solvent.

86. A method of reducing the surface tension of a conductive fluid flowing through an object comprising the acts of:
applying a charge having a first polarity to said conductive fluid prior to said conductive fluid passing though said object; and
providing a second electric charge having a second polarity downstream of said object, said second polarity being opposite of said first polarity.

87. The method as claimed in claim 86 wherein said act of applying said charge to said conductive fluid includes contacting said conductive fluid with an electrode.

88. The method as claimed in claim 86 wherein said object includes a filter.

89. The method as claimed in claim 86 wherein said object includes an orifice.

90. The method as claimed in claim 86 wherein said act of providing said second electric charge having said second polarity downstream of said object includes applying a charge to a conductive gas located downstream of said object.
